(19) United States
(12) Patent Application Publication
(10) Pub. No.: US 2011/0292210 A1
(43) Pub. Date: Dec. 1, 2011

(54) MEASUREMENT DEVICE, CONTROL DEVICE, AND STORAGE MEDIUM

(75) Inventor: Masami Mizutani, Kawasaki (JP)

(73) Assignee: FUJITSU LIMITED, Kawasaki-shi (JP)

(21) Appl. No.: 13/097,892

(22) Filed: Apr. 29, 2011

(30) Foreign Application Priority Data
May 26, 2010 (JP) 2010-120844

(51) Int. Cl. H04N 7/18

(52) U.S. Cl. 348/148; 348/159; 348/E07.085

(57) ABSTRACT

A measurement device includes: a plurality of calculation units configured to calculate a noise intensity, for a monitor area in an image data obtained by a camera having a plurality of image sensors, based on a pixel value of each of a plurality of pixels of the monitor area, and each of the plurality of calculation units calculates the noise intensity for different monitor areas in the image data; a selection unit configured to select a noise intensity from noise intensities calculated by each of the plurality of calculation units; and an output unit configured to output information based on the noise intensity selected by the selection unit.

### CROSS-REFERENCE TO RELATED APPLICATIONS

This application is based upon and claims the benefit of priority of the prior Japanese Patent Application No. 2010-120844, filed on May 26, 2010, the entire contents of which are incorporated herein by reference.

### FIELD

Various embodiments described herein relate to a measurement device that measures a noise intensity of an image sensor, and a control device and a storage medium that use the noise intensity measured by the measurement device.

### BACKGROUND

Images obtained by cameras have been used for various purposes such as for crime prevention. For example, cameras are installed at convenience stores and streets to monitor the obtained images for crime prevention. Moreover, a camera is used for a back-up or reverse monitor of a car to assist a driver to check a rearview which is difficult to see from a driver. The cameras for these purposes include an image sensor, for example, a Charge Coupled Device (CCD) sensor, and a Complementary Metal Oxide Semiconductor (CMOS), and display a obtained image on the monitor.

Recently, image processing is applied to an obtained image to display a recognition result from the obtained image on a monitor. For example, in a case of a camera installed on cars and so on, there is a technology to apply image processing to an image obtained by the camera and recognizes a moving object such as a vehicle approaching the car in the obtained image, and displays the moving object by surrounding, for example, with a frame on a monitor.

Noise may appear in a pick-up image. A plurality of image sensors in a camera has properties that electric outputs from respective image sensors are unstable. Noise is caused when an image sensor outputs a value that is different from an intensity of an optical signal received by the image sensor as a result of unstable output by the image sensor. Unstable output is caused in the image sensors individually.

When a large amount of noise is included in an image obtained by a camera, a moving image may be erroneously recognized by the above-described moving object recognition processing. For example, if an average luminance of the pick-up image is lower than a certain value, an Auto Gain Control (AGC) may be applied to the pick-up image in order to display the pick-up image that includes an object brighter on a screen when the image is obtained in a dark place. Applying the AGC processing amplifies a noise component included in a signal as well. As a result, grainy noise is caused on the pick-up image. When such grainy noise is distributed over the obtained image and position of the grainy noise is changed with time, such change of the position may be erroneously recognized as a movement of the above-described moving object.

For a technology to measure a noise intensity of a camera, there is a method that uses, for example, an optical black. The method measures a noise intensity by providing a light-shielded area outside of an effective pixel area of a camera, measuring a luminance value of the area, and comparing the luminance value with an ordinary black level. Japanese Laid-Open Patent Publication No. 2009-296147 discusses a technology that measures a noise intensity in a camera by using the above-described optical black method and determines, by a recognition device that is provided externally of the camera, whether image recognition processing of a pick-up image is executed according to the noise intensity.

### SUMMARY

According to an aspect of the invention, a measurement device includes: a plurality of calculation units configured to calculate a noise intensity, for a monitor area in an image data obtained by a camera having a plurality of image sensors, based on a pixel value of each of a plurality of pixels of the monitor area, and each of the plurality of calculation units calculates the noise intensity for different monitor areas in the image data; a selection unit configured to select a noise intensity from noise intensities calculated by each of the plurality of calculation units; and an output unit configured to output information based on the noise intensity selected by the selection unit.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a functional block diagram of a control device that includes a measurement device according to an embodiment;

FIG. 2 illustrates an operation of a measurement unit;

FIG. 3 is an example of image data;

FIG. 4 is a flowchart illustrating a processing operation according to an embodiment;

FIG. 5 illustrates an operation of a calculation unit;

FIG. 6 illustrates trend calculation processing and subtraction processing;

FIG. 7 illustrates an operation of a selection unit;

FIG. 8 illustrates an operation of a time-series processing unit;

FIG. 9 illustrates an example of coordinate data of a recognition target that is stored in a storage table;

FIG. 10 illustrates a monitor screen at low noise;

FIG. 11 illustrates a monitor screen at high noise;

FIG. 12 is a block diagram of an information processing device; and

FIG. 13 illustrates a method to provide programs and data.

### DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures. In the figures, dimensions and/or proportions may be exaggerated for clarity of illustration. It will also be understood that when an element is referred to as being “connected to” another element, it may be directly connected or indirectly connected, i.e., intervening elements may also be present. Further, it will be understood that when an element is referred to as being “between” two elements, it may be the only element between the two elements, or one or more intervening elements may also be present.

The noise intensity measurement by the above-described optical black method requires a processing unit in a camera to determine a noise level based on an optical black area of a pick-up image, thereby increasing the cost of the camera device. Even if a camera is provided with a processing unit to determine an optical black area and a noise level, an interface needs to be provided to output a noise level to a recognition device, thereby increasing the cost of the camera device as well.

Measuring a noise intensity from pick-up image data using an effective pixel area without using an optical black area is considered. However, a texture that is an actual image is changed in a pick-up image in an effective pixel area due to illumination of light, shading, and change in a background by a movement of a camera. Thus, separating texture and noise may difficult. Accordingly, measuring a noise intensity using an effective pixel area of an image sensor has been extremely difficult using conventional technologies.

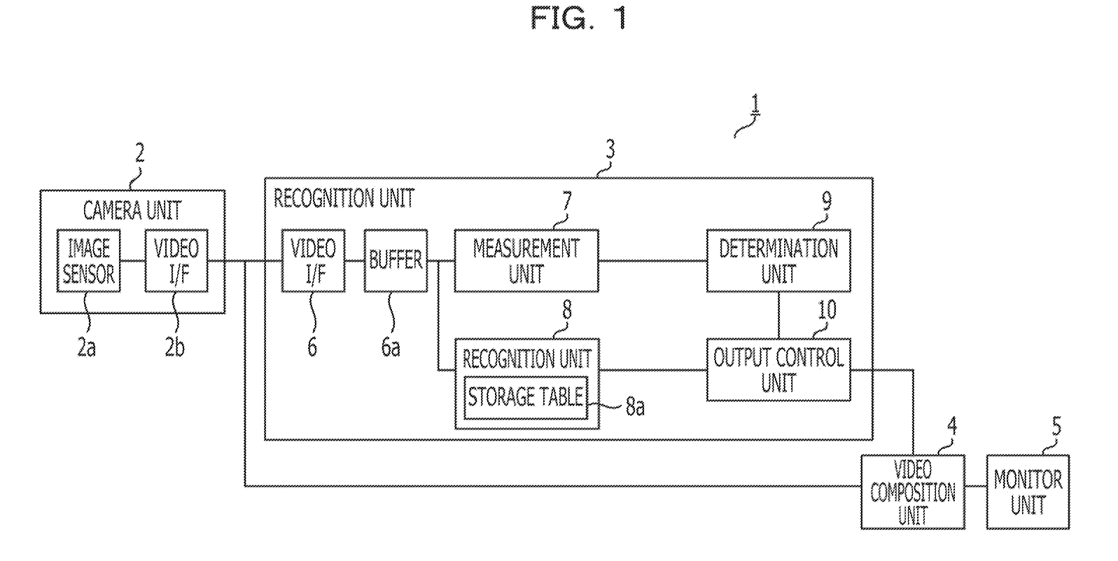

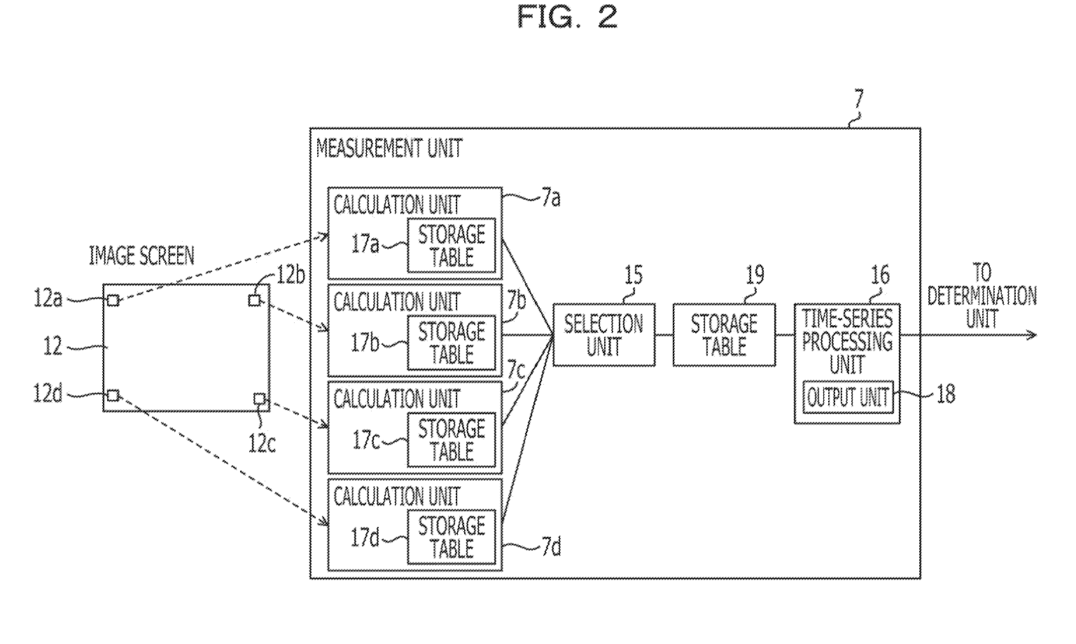

Hereinafter, an embodiment will be described by referring to accompanying drawings. FIG. 1 is a functional block diagram of a control device that includes a measurement device according to the embodiment. FIG. 2 illustrates an operation of a measurement unit.

In FIG. 1, a control device 1 includes a camera unit 2, a recognition unit 3, a video composition unit 4, and a monitor unit 5. The recognition unit 3 includes a video interface 6, a measurement unit 7, a recognition unit 8, a determination unit 9, and an output control unit 10. Hereinafter, the interface may be described as I/F. Furthermore, hereinafter, the measurement unit 7 may be described as a measurement device.

The camera unit 2 includes an image sensor 2a and a video I/F 2b. The image sensor 2a performs photoelectric conversion of light that is incident through a lens, which is not illustrated. Image data obtained by the image sensor 2a is output to a video image I/F 2b. The image sensor 2a includes a photoelectric conversion element such as a CCD sensor and a CMOS sensor, for example, and according to the embodiment, is provided, for example, in a camera unit 2 that is installed in a front part of a car to check a front status of the car. The image sensor 2a may typically include an effective pixel area.

The camera unit 2 includes an AGC circuit, which is not illustrated in FIG. 1. When an average luminance value of image data formed as one frame made up of image data obtained by the image sensor 2a is lower than a threshold, the AGC circuit may amplify luminance values of the image data so that the average luminance exceeds the certain value or threshold.

The video I/F 2b may be a standard video interface that complies, for example, with National Television Standards Commit (NTSC). The video I/F 2b converts, for example, image data into analog data and transmits to the recognition unit 3. Thus, the camera unit 2 according to the embodiment may include one video I/F 2b. Image data that is output from the camera unit 2 is transmitted to the video composition unit 4.

Image data converted into analog data is input to the video I/F 6 of the recognition unit 3 and is converted to digital data again by the video I/F 6.

The data obtained from the video I/F 6 is temporarily stored in a buffer 6a of the recognition unit 3. For example, the buffer 6a includes a storage area capable of retaining image data for 2 frames, in other words, 2 screens, retains one frame of image data that is input from the video I/F 6, and outputs one frame of pick-up image data that is already retained to the measurement unit 7 and the recognition unit 8.

The measurement unit 7 measures a noise intensity of image data in a monitor area, which will be described later, and outputs the measurement result to the determination unit 9. The noise intensity reflects how large the noise amount is. For example, the noise intensity may be represented by the number of pixels among pixels made up of one frame of image data that outputs a pixel value of a noise or a value estimated to be a noise, or by a ratio of such noise.

FIG. 2 illustrates an operation of the measurement unit 7. The measurement unit 7 includes four calculation units 7a, 7b, 7c, and 7d, and a time-series processing unit 16. The measurement unit 7 measures, for example, substantially the minimum noise intensity from image data. The measurement result is selected by a selection unit 15 and stored in a storage table 19. A result of processing by the time-series processing unit 16 using the measurement result stored in the storage table 19 is output from an output unit 18 provided in the time-series processing unit 16 to the determination unit 9. The measurement result selected by a selection unit 15 is stored in a storage table 19. A result of processing by the time-series processing unit 16 using the measurement result stored in the storage table 19 is output to the determination unit 9 from the output unit 18 provided in the time-series processing unit 16. In FIG. 2, an example that the measurement unit 7 includes four calculation units is illustrated. For example, the number of calculation units may be two or more.

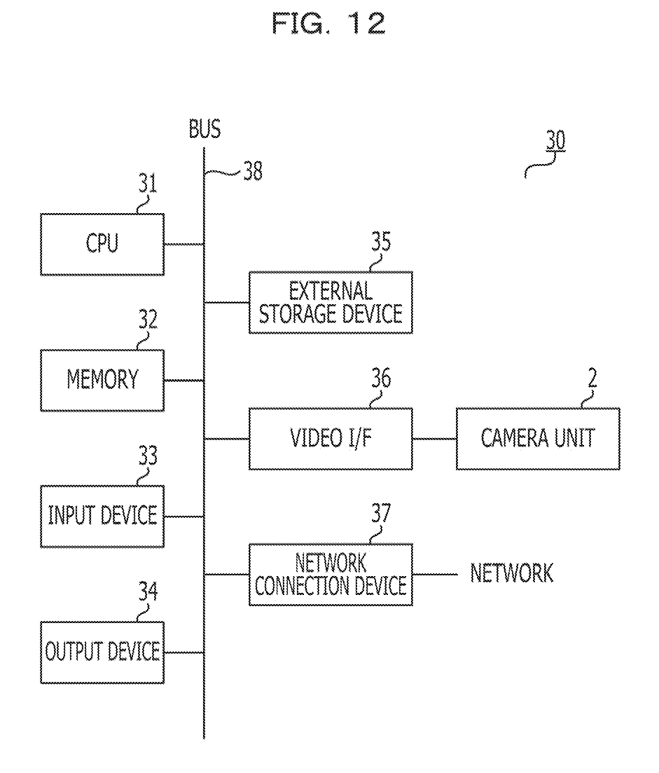

The calculation units 7a, 7b, 7c, and 7d calculate noise intensities of monitor areas that are set by setting processing, which will be described later. In the example illustrated in FIGS. 2, 12a, 12b, 12c, and 12d that are located at four corners of an obtained image 12, which is screen data, are set as monitor areas. A noise intensity for each of the monitor areas 12a to 12d is calculated by calculation units for each of the monitor areas. The calculation units 7a, 7b, 7c, and 7d store information of the noise intensities calculated by respective circuits in storage tables 17a, 17b, 17c, and 17d of the calculation units 7a, 7b, 7c, and 7d respectively. For example, information of the noise intensity calculated by the calculation unit 7a is stored in the storage table 17a.

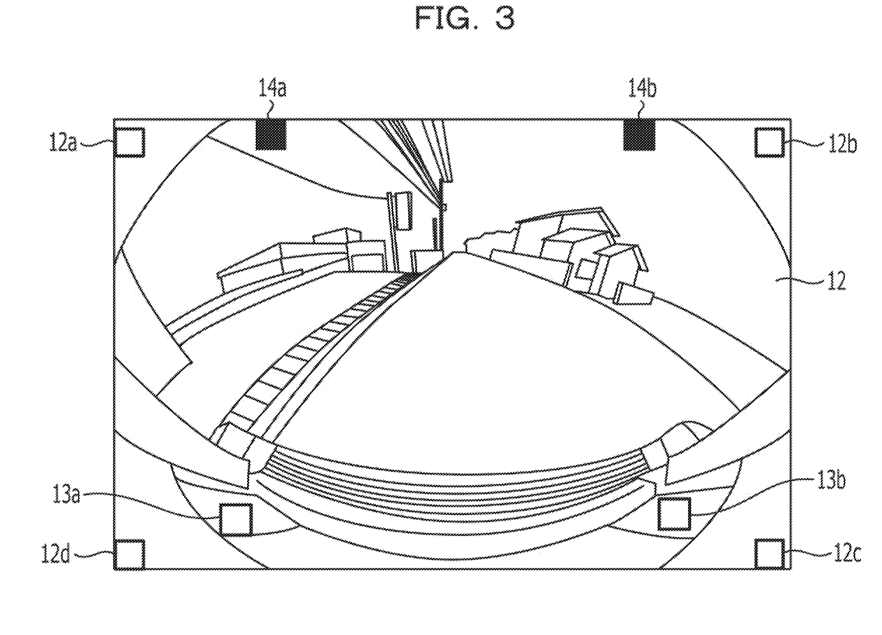

FIG. 3 is an example of image data, and for instance, an example of image data obtained by the image sensor 2a of the camera unit 2 mounted, for example, to a front part of a car. In the example, the monitor areas 12a, 12b, 12c, and 12d are surrounded by a substantially square frame located at four corners of the image 12. The camera 2 according to the embodiment uses a wide-angle lens in order to cover a wide area in front of the car. Meanwhile, the image sensor 2a is made up of many photoelectric conversion elements that may be laid out by a matrix of 480×720 elements, thereby the image pick-up screen 12 may be a rectangular shape. Thus, the monitor areas 12a, 12b, 12c, and 12d are where reflection of an image from the wide-angle lens that uses a circular convex lens is extremely small.

The selection unit 15 selects, for example, substantially the lowest noise intensity among noise intensities calculated by the calculation units 7a to 7d and stores the noise intensity in the storage table 19. The time-series processing unit 16 reads data stored in the storage table 19, performs noise intensity averaging processing, and outputs the value to the determination unit 9.

When a noise intensity that is output from the output unit 18 of the measurement unit 7 is smaller than a threshold, the determination unit 9 outputs an on-signal to the output control unit 10. In response to the on-signal, the output control unit 10 outputs a result recognized from image data by the recognition unit 8 to the video composition unit 4. When a noise intensity that is output from the output unit 18 of the measurement unit 7 is the threshold or more, the determination unit 9 outputs an off-signal to the output control unit 10. For the off-signal, the output control unit 10 does not output a result recognized from the image data by the recognition unit 8 to the video composition unit 4. The threshold that is used by the determination unit 9 to determine a noise intensity may be set and stored in a storage area, which is not illustrated.

The recognition unit 8 performs recognition processing based on image data that is input through the video I/F 6. For example, the recognition processing detects a subject in the image data that exhibits a characteristic movement and stores coordinate data in an image frame of the subject in the storage table 8a as a recognition result. For example, a subject that moves toward a center of the screen is detected as a subject that exhibits a characteristic movement and coordinate data of the subject is stored in the storage table 8a as a recognition result.

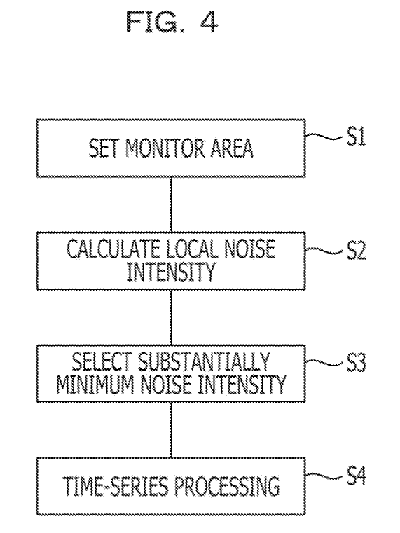

Processing operations according to the embodiment in the above-described configuration will be described. FIG. 4 is a flowchart illustrating processing operation according to the embodiment. A processor of the control device 1 performs processing to set monitor areas (Operation S1). The processing sets the previously described plurality of monitor areas. It is desirable that an area where change in the pick-up image is small is set as a monitor area. According to the embodiment, the four corners of the pick-up image 12 where reflection of an image caused by properties of the wide-angle lens is extremely small are set as the monitor areas 12a to 12d.

As illustrated in FIG. 3, areas 13a and 13b where a part of a car body is reflected may be set as monitor areas where texture change with a movement of a camera position is small. Alternatively, light-shield seals may be attached over the image sensor 2a, and areas 14a and 14b on the image data 12 that correspond to areas of the image sensor 2a to which the light-shield seals are attached may be set as monitor areas. Even in a camera that does not use a wide-angle lens, setting monitor areas as described above allows to set monitor areas where shading and reflection due to reflection in the lens is small.

Operation S1 may be performed at timing which is not successive points in time from Operation S2 and thereafter. Moreover, Operation S1 may be performed by an instruction input operation that identifies a monitor area by a user instead of by the processor of the control device 1. In this case, the user may input a position of a monitor area in the image data 12 as coordinate information of the image data 12. Furthermore, when the measurement unit 7 (measurement device) includes a processor independent of the control device 1, Operation S1 may be performed by a processor of the measurement unit 7.

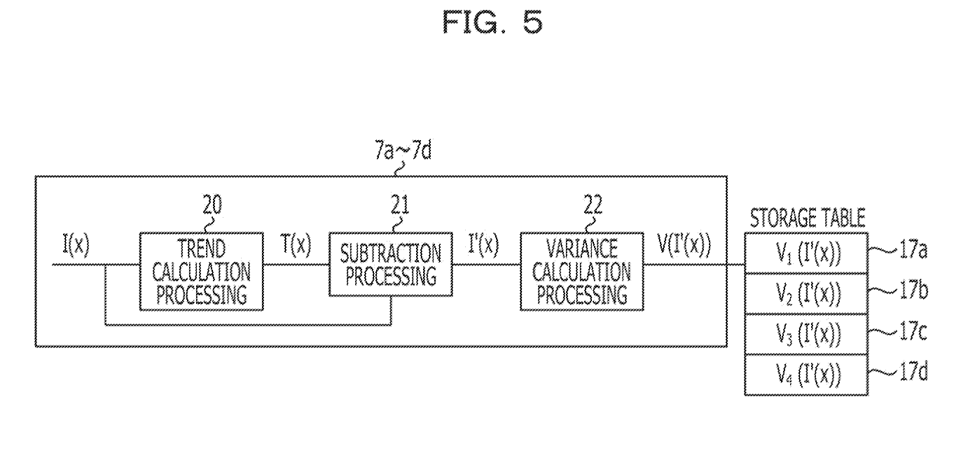

The calculation units 7a to 7d calculate local noise intensities of each of the monitor areas (Operation S2). Image data that is input to the calculation units 7a to 7d may include shading and reflection due to reflection in the lens because the corresponding monitor areas 12a to 12d are not completely light-shaded. Each of the calculation units 7a to 7d performs operation illustrated in FIG. 5 in order to reduce influence of shading and reflection in the lens on noise calculation. For example, a trend calculation processing 20, a subtraction processing 21, and a variance calculation processing 22 are performed sequentially.

Image data of the monitor area 12a is input to the calculation unit 7a. Image data of the monitor area 12b is input to the calculation unit 7b. Image data of the monitor area 12c is input to the calculation unit 7c. Image data of the monitor area 12d is input to the calculation unit 7d.

The calculation units 7a to 7d calculate a trend (T(x)) for luminance values of pixels (I(x)) in the monitor areas 12a to 12d that correspond to each of the calculation units (for example, the monitor area 12a for the calculation unit 7a) according to the expression below.

T(x)=−Σᵢw(i)I(x−i)/σ

The i=(p,q) is a variable to represent a local area around a coordinate x over a two-dimensional plane, and, for example, may be defined as −5≦p≦5, and −5≦q≦5. The above-described w indicates a weight coefficient, while the σ indicates a normalized constant.

The calculation units 7a to 7d perform subtraction processing that subtracts the trend (T(x)) that is the above described calculation result from the luminance value (I(x)) according to the expression below and obtains the subtraction result I′(x).

I′(x)=I(x)−T(x)

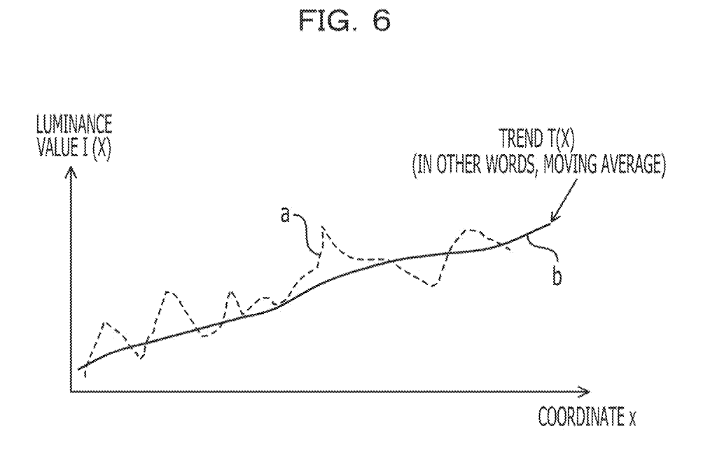

FIG. 6 illustrates the above-described trend calculation processing 20 and the subtraction processing 21. In FIG. 6, the horizontal axis is “x” coordinates of one horizontal line in one monitor area and illustrates how luminance values (I(x)) and the trend (T(x)) change. The curved line “a” in FIG. 6 indicates luminance values (I(x)) corresponding to “x” coordinates of one horizontal line in one monitor area (for example, 12a). The line graph “b” in FIG. 6 indicates how the trend (T(x)) corresponding to “x” coordinates of one monitor area (for example, 12a) changes.

For example, the above-described trend (T(x)) is a moving average of luminance values and calculated as an average of luminance values of pixels around a pixel x. The example in FIG. 6 illustrates that in a corresponding monitor area (for example, 12a), the luminance value is gradually increased by influence of texture, shading, and reflection due to reflection in the lens with the increase of values of the x coordinates, and the trend (T(x)) becomes an upward-sloping line. Although not illustrated, contrary to the example of FIG. 6, in a monitor area (for example, 12a), the trend (T(x)) becomes a downward-sloping line when influence of texture, shading, and reflection due to reflection in the lens is gradually decreased with the increase of values of the x coordinates.

Hence, according to the embodiment, the subtraction processing 21 subtracts trends (T(x)) from luminance values (I(x)) to obtain the luminance values (I′(x)) in order to calculate noise intensities included in the luminance values more accurately.

The calculation units 7a to 7d perform the variance calculation processing 22 and calculates a variance V of the above-described luminance values (I′(x)) according to the expression below. The calculation units 7a to 7d store the calculation results in corresponding storage tables 17a to 17d.

$$V = \frac{{\sum }_{z ∈ R}^{ } {( {I}^{′} ( x ) - {\overline{I}}^{t} )}^{2}}{s}$$

The R defines a local area, the Ī′ is an average of (I′(x)) in the area R, and s is a pixel area of the area R (for two dimensional coordinates x=(u, v), 10≦u<19, 10≦v<19, s=400 when R=[10, 10, 20, 20] (x coordinate and y coordinate of a top left of a rectangular area, width, and height)).

Variances as described below are stored in the storage tables 17a to 17d through the above-described processing. For example, a variance V₁ based on image data of the monitor area 12a is stored in the storage table 17a, a variance V₂ based on image data of the monitor area 12b is stored in the storage table 17b, a variance V₃ based on image data of the monitor area 12c is stored in the storage table 17c, and a variance V₄ based on image data of the monitor area 12d is stored in the storage table 17d.

Instead of processing of the trend calculation, subtraction, and variance calculation, the following processing may be conducted. A total of the differences between an average luminance for all of the monitor areas 12a to 12d and a luminance value of each pixel in the monitor areas 12a to 12d is calculated. The calculation results may be stored in the storage tables 17a to 17d as luminance variances corresponding to the monitor areas 12a to 12d respectively.

The above-described variance V indicates variations of luminance values (I′(x)). The above expression indicates when variations of the luminance values (I′(x)) are smaller, change in luminance values due to factors other than noise, such as texture, shading, and reflection due to reflection in the lens is more decreased.

Generally, noise may be substantially uniformly regardless of positions in the image frame. Thus, a variance due to noise is substantially constant wherever monitor areas are set in the image data. On the other hand, data of an obtained image, in other words, texture of the image data, and reflection of image due to reflection in the lens change depending on a type of a subject, and where the subject is positioned in the image data, and moreover where shading of external light or reflection due to reflection in the lens are caused in the image data. In other words, a probability that substantially the same texture, shading, and reflection due to reflection in the lens are caused at substantially the same timing are extremely low. Accordingly, a variance due to texture and reflection due to reflection in the lens changes depending on where monitor areas are set in the image data.

Moreover, generally, a variance of luminance values due to texture and reflection in the lens is much greater than a variance of luminance values due to noise. Therefore, when a variance of luminance values due to texture and reflection in the lens is large, a variance obtained from the image data is large as well. The value of the variance of the monitor areas is obtained by totaling the variance due to factors other than noise such as texture and reflection in the lens, and the variance due to noise. Hence, when the variance of luminance values due to factors other than noise is large, the variance of luminance values due to factors other than noise dominates the variance obtained from image data compared with the variance of luminance values due to noise.

Conversely, when a variance of luminance values due to factors other than noise is small, the variance obtained from the image data decreases. Moreover, when a variance of luminance values due to factors other than noise is small, a variance of luminance values due to noise is more likely to be reflected in the variance obtained from the image data. In other words, the variance obtained from the image data becomes a value close to a variance of luminance values due to noise.

Accordingly, the smaller the variances V(I′(x)) stored in the storage tables 17a to 17d, in other words, the smaller variations of the luminance values (I′(x)), the variance of luminance values due to noise is more accurately reflected. In other words, the smaller the above-described variance V, the more accurate noise intensity is represented.

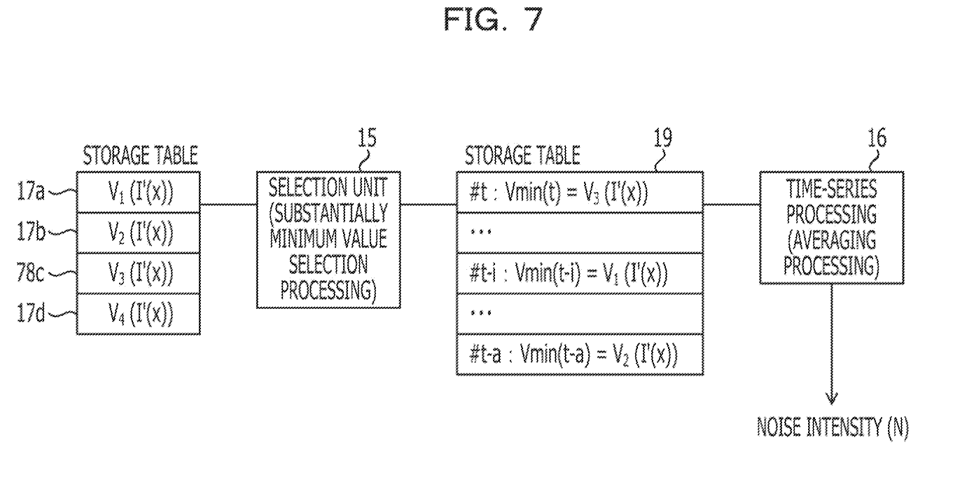

Processing to select, for example, substantially the minimum noise intensity from noise intensities calculated by the calculation units 7a to 7d, in other words, from variances V is performed (Operation S3). The selection unit 15 executes Operation S3. FIG. 7 illustrates the processing. In the processing of selecting substantially the minimum value, the selection unit 15 selects substantially the minimum variance from the variances V stored in the above-described storage tables 17a to 17d and stores the selected value in the storage table 19 as a variance Vmin. For example, at time t, data of variance V₃ stored in the storage table 17c is read as a variance Vmin(t) and stored in a storage area (#t). Moreover, at time t−i, data of variance V₁ stored in the storage table 17b is read and stored in a storage area (#t−i). Furthermore, at time t−a, data of variance V₂ stored in the storage table 17a is read and stored in a storage area (#t−a).

In other words, the above-described processing corresponds to processing to select variances of the monitor areas 12a to 12d where influence of texture, shading, and reflection due to reflection in the lens is substantially the smallest. The processing utilizes that a probability of causing shading and reflection due to reflection in the lens in all of the monitor areas 12a to 12d at substantially the same time is extremely low.

The selection unit 15 may select an average value of a certain number of noise intensities from substantially the smallest noise intensity among noise intensities for the plurality of monitor areas or may select “n” th noise intensity (where n is a certain number) from substantially the smallest noise intensity among noise intensities for the plurality of monitor areas instead of selecting substantially the minimum noise intensity. The certain number may be, for example, a value less than a half of the monitor areas.

When the selection unit 15 selects substantially the minimum noise intensity, a variance, in other words, a noise intensity with the least influence of texture and so on, may be selected. Moreover, when the selection unit 15 selects an average value of a certain number of noise intensities from substantially the smallest noise intensity or selects “n” th noise intensity (where n is a certain number) from substantially the smallest noise intensity among noise intensities for the plurality of monitor areas, even if a pixel value on image data for one area of areas set as monitor areas becomes an abnormal value for some failures, influence of the abnormal value on the calculation of noise intensity may be reduced.

Time-series processing is performed (Operation S4). The time-series processing unit 16 executes the S4. The S4 is processing to further reduce influence of texture, shading, and reflection due to reflection in the lens. In other words, the time-series processing unit 16 sequentially reads data of variances Vmin stored in the storage table 19 and calculates noise intensity (N). For example, processing to average variances Vmin that are temporally continuous is performed according to the expression below.

N=ΣᵢVmin(t−i)/a(i=1 . . . a)

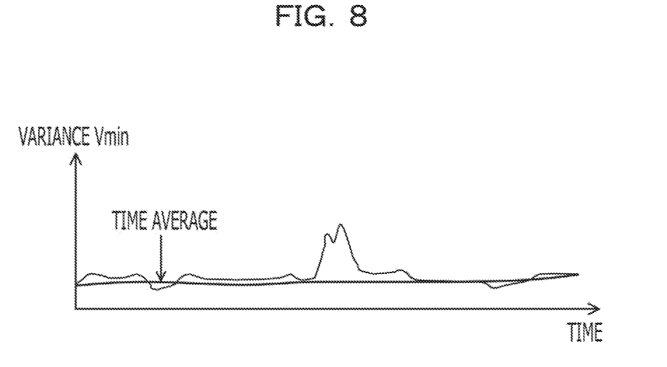

In other words, as illustrated in FIG. 8, a noise intensity may be calculated by sequentially reading data of variances Vmin that are temporally continuous from the storage table 19 and by performing averaging processing in a local window a. The processing utilizes that a probability of causing texture, shading, and reflection due to reflection in the lens at substantially the same time and for a long period of time is extremely low.

As described above, the time-series processing unit 16 performs averaging processing of variances Vmin to obtain a noise intensity and outputs the obtained noise intensity to the determination unit 9. The determination unit 9 generates a signal for controlling output of the recognition result by the recognition unit 8. For example, the determination unit 9 outputs an on-signal to the output control unit 10 when a noise intensity that is output from the measurement unit 7 is smaller than a threshold. On the other hand, the determination unit 9 outputs an off-signal to the output control unit 10 when the above-described noise intensity is equal to or larger than the threshold.

As described above, image data is input to the recognition unit 8 through the buffer 6a. The recognition unit 8 performs recognition processing for the input image data, and extracts, for example, a subject that exhibits a characteristic movement. For example, a moving object that moves toward a center of a screen is extracted. A camera is mounted on the front part of the car. When the car is moving forward, the moving object that is moving toward the center of the screen corresponds to a vehicle or a human that approaches the car, or a moving object that may become an obstacle to a passage of the car. The recognition unit 8 stores such subject as a recognition target in the table 8a for each frame that is a storage and recognition processing target.

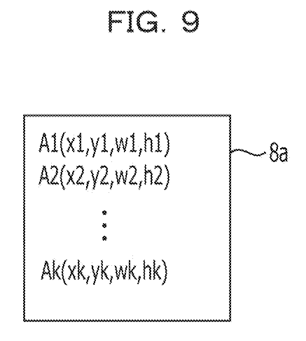

FIG. 9 illustrates an example of coordinate data of recognition targets that are stored in the storage table 8a. For example, data A1 (x1, y1, w1, h1), A2 (x2, y2, w2, h2), . . . Ak (xk, yk, wk, hk) are stored as a set of an identifier and coordinates of the moving object that is a recognized target (x coordinate, y coordinate, a width w from the x coordinate, a height h from the y coordinate). When a noise intensity that is output from the output unit 18 of the time-series processing unit 16 is smaller than a threshold, data stored in the storage table 8a is output to the video composition unit 4 through the output control unit 10. Image data that is obtained by the image sensor 2a is input to the video composition unit 4 as well. The video composition unit 4 composites the above-described recognition result and the image data, and outputs the composite data to the monitor unit 5.

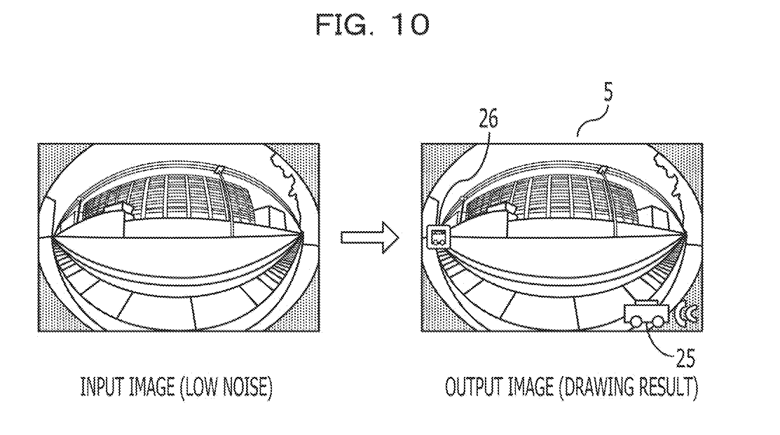

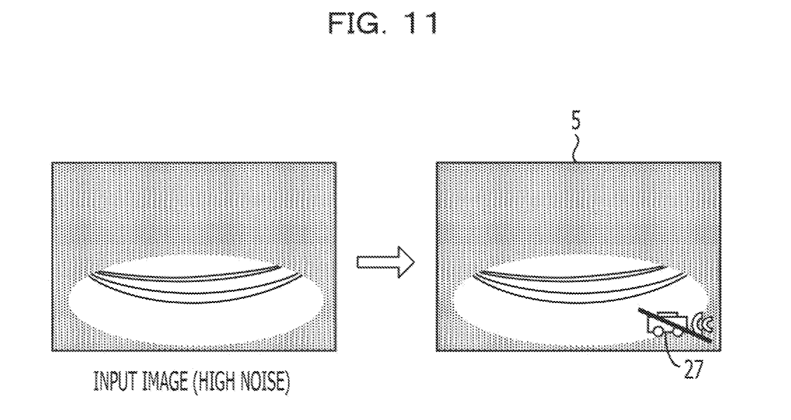

FIGS. 10 and 11 illustrate display examples of the monitor unit 5. FIG. 10 is a display example when the noise intensity is smaller than a threshold, in other words, an amount of noise is small. A state in which an amount of noise is small may be expressed as a low noise. In this case, the monitor unit 5 displays a frame 26 that substantially surrounds a subject that is a recognition result. The image data in the frame 26 is displayed based on coordinate data of the subject recognized by the recognition unit 8, and for example, coordinates data of the above-described recognition target A1 (x1,y1,w1,h1) in FIG. 9. Using the display allows the driver of the car to recognize a subject that is substantially surrounded by the frame 26 is approaching the car by viewing the frame 26 displayed in the monitor 5.

An operation-on indicator 25 illustrated in FIG. 10 indicates the recognition unit 8 is in operation. Using the indicator allows the driver of the car to find the recognition unit 8 is in operation by viewing the operation-on indicator 25 displayed in the monitor unit 5.

FIG. 11 is a display example when a noise intensity is equal to or larger than a threshold, in other words, an amount of noise is large. A state in which noise amount is large may be expressed as a high noise. An amount of noise is large when many grainy noises are caused that change positions as time elapses. The positional change of the grainy noises may be erroneously detected by the recognition unit 8 as movement of the subject. In this case, the determination unit 9 outputs an off-signal to the output control unit 10 and thereby the frame 26 that indicates the recognition result is not displayed in the monitor 5. Thus, even if the recognition unit 8 erroneously recognizes positional change of grainy noise as a movement of the subject, the erroneously recognized result is not displayed on the monitor unit 5. Accordingly, misleading the driver of the car by displaying the frame 26 that is the erroneously recognized result may be suppressed. Moreover, the monitor unit 5 may display an operation-off indicator 27 that indicates the operation of the recognition unit 8 is discontinued. Using the display allows the driver of the car to clearly recognize that the recognition unit is not in operation.

Moreover, for example, when an average luminance of image data is less than the value or threshold, the AGC circuit amplifies the luminance of the image data so that the average luminance exceeds the value or threshold. When a noise intensity included in the amplified image data is the above described threshold, the determination unit 9 outputs an off-signal to the output control unit 10. Thus, image data in which a frame 26 is composited as a recognition result from the recognition unit 8 is not displayed on the monitor unit 5.

According to the embodiment, four monitor areas 12a to 12d, or two monitor areas either of 13a and 13b, or 14a and 14b are set. However, the number of monitor areas is not limited to the above-described number. Three, five, or more monitor areas may be set. The number of calculation units to operate may be increased or decreased according to the number of monitor areas.

A plurality of blocks obtained by dividing the image frame 12 into substantially uniformly sized blocks may be set as monitor areas. Setting the monitor areas in this manner enables to set a monitor area with little influence of shading and reflection due to reflection in the lens as described above even for a camera that does not use a wide-angle lens. The above-described plurality of monitor areas 13a and 13b, or 14a and 14b, or block areas are desirably set in areas that are spaced apart in the above described image data. However, the monitor areas are not necessarily set to be spaced apart.

There are two monitor areas, 13a and 13b, or 14a and 14b, when a part of a car body where influence of reflection is little are set as monitor areas 13a and 13b, or when seals are attached on the image sensor 2a and corresponding areas in the image pick-up screen are set as monitor areas 14a and 14b. Accordingly, two calculation units, for example, 7a and 7b are used. In this case, the selection unit 15 selects substantially the minimum variance Vmin from outputs of the calculation unit 7a and 7b.

When light-shield seals are attached over a lens of the pick-up image 2a, the light-shield seals are attached at upper corners of a camera view so that, for example, monitor areas of approximately 20×20 pixels are set and the seals do not interfere with the subject as illustrated in FIG. 3. Black paint may be applied instead of attaching the light-shield seals.

Furthermore, according to the embodiment, the camera is installed to a front part of the car. Thus, the camera may be used, for example, as a camera device to cover a blind spot at a street. In this case, when a noise intensity is less than the threshold, the image composition unit 4 composites image data with coordinate data recognized by the recognition unit 8 and may alert the driver by displaying a frame substantially surrounding a vehicle that is in a blind spot.

A measurement device and a control device according to the embodiment may be used as a back or reverse monitor of the car. Using the measurement device and a control device as the back or reverse monitor may ensure greater safety of a rear part of the car, for example.

According to the embodiment, typically one standard video I/F 2b to process image data from the image sensor 2a may be provided in the camera unit 2. An optical black area is not required in the image sensor 2a. For example, according to a related art that provides an optical black area in a camera, a dedicated line is needed to notify information whether a recognition unit should perform recognition processing other than a line to output an image signal from a camera unit to the recognition unit. However, according to the embodiment, lines other than a line to output an image signal are not required; thereby the circuit may be simplified. As such, cost of the device may be reduced.

According to the embodiment, the measurement device and the control unit used for the camera device for a car is described. However, the measurement device and the control unit may be used for cameras installed at convenience stores and streets. Furthermore, the measurement device and the control unit may be used for various types of surveillance monitors such as a road surveillance monitor installed at streets and so on.

The control device in FIG. 1 may be achieved by using the information processing device (e.g., a computer) 30. The information processing device 30 in FIG. 12 includes a CPU 31, a memory 32, an input device 33, an output device 34, an external storage device 35, a video I/F 36, and a network connection device 37. Each of the above described components are mutually connected.

The memory 32 includes, for example, a Read Only Memory (ROM) and a Random Access Memory (RAM) and stores programs and data used for processing. Programs that are stored in the memory 32 include programs that execute the above-described measurement processing of noise intensity illustrated in FIG. 4. The CPU 31 measures noise intensity by executing the programs in the memory 32. In other words, the CPU 31 virtually functions as the measurement unit 7, the recognition unit 8, the determination unit 9, the output control unit 10, and the video composition unit 4.

Furthermore, when the measurement unit 7 is implemented as a separate device (measurement device) that is communicable with the control device 1, the implementation is achieved, for example, by using the information processing device (computer) 30 in FIG. 12. In this case, the CPU 31 virtually functions as the measurement unit 7.

The input device 33 is a pointing device such as a keyboard and a mouse, and used by a user to input instructions and information. The output device 34 is, for example, a display and a printer, and corresponds to the above-described monitor unit 5.

The external storage device 35 is, for example, a magnetic disk device, an optical

disk device, and a magnetic tape device. The above-described programs and data are stored in the external storage device 35 and are loaded to the memory 32 as needed.

The video I/F 36 controls inputs of pick-up images that are input from the camera unit 2. The video I/F 36 corresponds to the video I/F 6 in FIG. 1. The network I/F 37 is connected to a wired or a wireless communication networks such as a Local Area Network (LAN), and performs data conversion that is involved for communication. The information processing device 30 receives programs and data from an external device through the network I/F 37 as needed and uses the programs and data by loading to the memory 32.

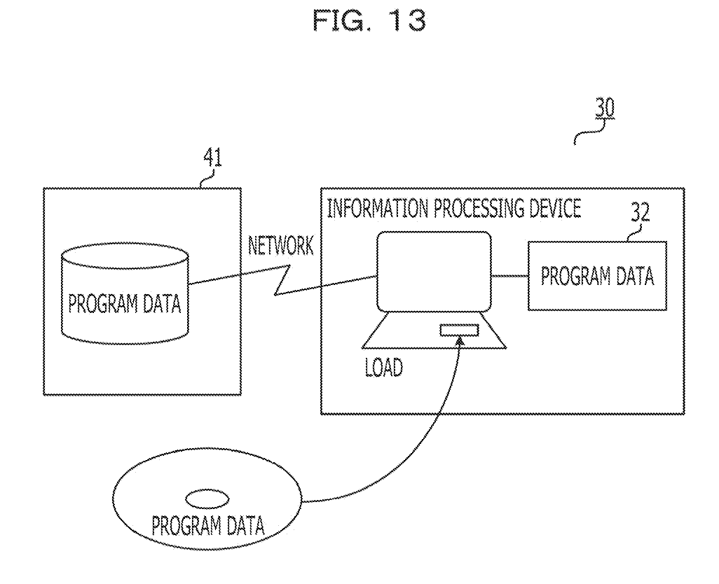

FIG. 13 illustrates a method to provide programs and data to the above described information processing device 30 in FIG. 12. For example, programs and data stored in the external storage device 35 are loaded to the memory 32 of the information processing device 30. An external device 41 that is connectable through the network I/F 37 generates a carrier signal that carries programs and data and transmits the programs and data to the information processing device 30 through a transmission medium over the communication network. The CPU 31 executes programs acquired by each of the above described methods and performs the above described processing to measure noise intensities.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal. The media described above may be non-transitory media.

According to an aspect of the embodiments of the invention, any combinations of one or more of the described features, functions, operations, and/or benefits can be provided. A combination can be one or a plurality. In addition, an apparatus can include one or more apparatuses in computer network communication with each other or other apparatuses. In addition, a computer processor can include one or more computer processors in one or more apparatuses or any combinations of one or more computer processors and/or apparatuses. An aspect of an embodiment relates to causing one or more apparatuses and/or computer processors to execute the described operations.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. A measurement device comprising:
a plurality of calculation units configured to calculate a noise intensity, for a monitor area in an image data obtained by a camera having a plurality of image sensors, based on a pixel value of each of a plurality of pixels of the monitor area, and each of the plurality of calculation units calculates the noise intensity for different monitor areas in the image data;
a selection unit configured to select a noise intensity from noise intensities calculated by each of the plurality of calculation units; and
an output unit configured to output information based on the noise intensity selected by the selection unit.

2. The measurement device according to claim 1, wherein the pixel value of each of the pixels of the monitor area is a value obtained by subtracting a moving average of luminance values of the image data from a luminance value detected by each of the image sensors which respectively corresponding to each of the pixels.

3. The measurement device according to claim 1, further comprising:
a time-series processing unit configured to obtain information of the noise intensity selected by the selection unit in time series, to calculate an averaged noise intensity by averaging the noise intensity in time series in a time window, and to output information related to the averaged noise intensity to the output unit.

4. The measurement device according to claim 1, wherein the plurality of the monitor areas are at least two of four corners of the image data when the plurality of image sensors receive light that is incident through a wide-angle lens.

5. The measurement device according to claim 1, wherein the selection unit selects substantially the smallest noise intensity among noise intensities calculated by the calculation units.

6. The measurement device according to claim 1, wherein the plurality of monitor areas are set in an area of the image data where a part of a vehicle is viewed when the camera is installed to the vehicle.

7. The measurement device according to claim 1, wherein the plurality of monitor areas are a plurality of block areas obtained by dividing the image data substantially uniformly.

8. A control device comprising:
a plurality of calculation units configured to calculate a noise intensity, for a monitor area in an image data that is obtained by a camera having a plurality of image sensors, based on a pixel value of each of a plurality of pixels of the monitor area, and each of the plurality of calculation units calculates the noise intensity for different monitor areas in the image data;
a selection unit configured to select a noise intensity from noise intensities calculated by each of the plurality of calculation units;
a determination unit configured to determine whether image composition is applied to the image data based on recognition information obtained from the image data, according to information of the noise intensity selected by the selection unit; and
a video composition unit configured to output one of the image data and a composite image that is obtained by compositing the image data with information based on the recognition information.

9. The control device according to claim 8, wherein the determination unit determines to composite the image data with the recognition information when the noise intensity is smaller than a threshold; and
the video composition unit composites the image data with information based on the recognition information.

10. The control device according to claim 8, wherein the recognition information is coordinate data of a moving object that moves toward a center of the image data.

11. A non-transitory computer-readable medium for recording a measurement program allowing a computer to execute:
calculating a noise intensity for each of a plurality of monitor areas in an image data that is obtained by a camera having a plurality of image sensors, based on pixel values of each of a plurality of pixels of each of the plurality of the monitor areas;
selecting a noise intensity from a plurality of noise intensities calculated by the calculating; and
outputting information based on the noise intensity selected by the selecting.

12. A non-transitory computer-readable medium for recording a control program allowing a computer to execute:
calculating a noise intensity for each of a plurality of monitor areas in an image data obtained by a camera having a plurality of image sensors, based on pixel values of each of a plurality of pixels of each of the plurality of the monitor areas;
selecting a noise intensity from a plurality of noise intensities calculated by the calculating;
determining whether image composition is applied to the image data based on recognition information obtained from the image data, according to information of the noise intensity selected by the selecting; and
outputting one of the image data and an image obtained by compositing the image data with information based on the recognition information.
